(19) United States
(12) Patent Application Publication
(10) Pub. No.: US 2012/0223034 A1
(43) Pub. Date: Sep. 6, 2012

(54) SNOWPLOW DISPLAY APPARATUS AND METHOD

(76) Inventor: Craig Kemmerling, Twinsburg, OH (US)

(21) Appl. No.: 13/040,848

(22) Filed: Mar. 4, 2011

(51) Int. Cl. A47F 1/04; B23P 11/00

(52) U.S. Cl. 211/59.2; 29/428

(57) ABSTRACT

A snowplow exhibit apparatus may be used to display at least two snowplows at two different heights in multiple upper levels, in additional to the ground level.

### I. BACKGROUND

A. Field of Invention

This invention generally relates to methods and apparatuses concerning the display or exhibition of snowplows and more specifically to methods and apparatuses concerning the display of snowplows above each other.

B. Description of the Related Art

It is long known to display snowplows at tradeshows, conventions and the like by simply positioning the snowplow on a ground level, or on a platform just above ground level. While this known method works adequately for its intended purpose, it has drawbacks. One drawback is that the attendees/viewers can only become aware of the snowplow when they are relatively close to it. It is virtually impossible to become aware of the snowplow from across the tradeshow room do to the relatively large number of people attending the tradeshow, the relatively large rooms that are typically used, and the relatively short height of snowplows. Another drawback is related to floor space. Floor space at tradeshows is valuable and thus expensive. In order to display numerous snowplows using known apparatuses and methods, it is necessary to rent large areas of floor space and thus to undesirably increase the cost for the display.

What are needed are snowplow display apparatuses and methods that permit snowplows to be visible from relatively large distances and that enable numerous snowplows to be displayed while using relatively little floor space.

### II. SUMMARY

The present invention is an improvement for displaying snowplows. The snowplow exhibit apparatus may include: a first snowplow display structure that is suitable to support a first snowplow weighing at least 50 pounds at a first height; a second snowplow display structure that is connected to the first snowplow display structure and that is suitable to support a second snowplow weighing at least 50 pounds at a second height that is substantially higher than the first height; and, wherein when the first and second snowplows are supported to the first and second snowplow display structures, they are both simultaneously visible to an observer near the snowplow exhibit apparatus.

In accordance with another aspect of the present invention, a snowplow exhibit apparatus includes: a first snowplow display structure that is suitable to support a first snowplow weighing at least 100 pounds at a first height, the first snowplow display structure comprising: a platform that is suitable to support a snowplow blade of the first snowplow; and, a connection structure that is suitable to connect to a plow mount of the first snowplow; a second snowplow display structure that is connected to the first snowplow display structure and that is suitable to support a second snowplow weighing at least 100 pounds at a second height that is substantially higher than the first height, the second snowplow display structure comprising: a platform that is suitable to support a snowplow blade of the second snowplow; and, a connection structure that is suitable to connect to a plow mount of the second snowplow; a signage support structure that is suitable to support an sign at a fifth height that is substantially higher than the second height; and, wherein when the first and second snowplows are supported to the first and second snowplow display structures and when the sign is supported to the signage support structure, the first snowplow, the second snowplow and the sign are all simultaneously visible to an observer near the snowplow exhibit apparatus.

In accordance with still a further aspect of the present invention, a method includes the steps of: (A) providing a snowplow exhibit apparatus comprising: a first snowplow display structure; and, a second snowplow display structure that is connected to the first snowplow display structure; (B) providing first and second snowplows each weighing at least 50 pounds; (C) mounting the first snowplow to the first snowplow display structure at a first height; (D) mounting the second snowplow to the second snowplow display structure at a second height that is substantially higher than the first height; and, wherein after steps (A) through (D) the first and second snowplows are both simultaneously visible to an observer near the snowplow exhibit apparatus.

As an advantage, the present invention provides a structure with which multiple level display is possible. The apparatus allows at least two levels available for showing a product weighing at least 50 pounds (lbs). Therefore, more products can be shown from a unit cell space in a tradeshow with limited floor space. The structure allows the second level or above to be substantially higher in the air than the first, so that people from far away will see it, including the characters displayed in the snowplow, such as a trademark.

Other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1a shows a front perspective view of an exhibit apparatus for snowplows with straight blades.

FIG. 1b shows a side view of an exhibit device for snowplows with straight blades.

FIG. 1c shows a front perspective view of an apparatus for snowplows with V-blades.

FIG. 2a shows a perspective view of a snowplow with a straight blade attached to a vehicle.

FIG. 2b shows a front view of a snowplow with a straight blade.

FIG. 2c shows a rear view of a snowplow with a straight blade.

FIG. 3a shows a front view of a snowplow with V-blades.

FIG. 3b shows a rear view of a snowplow with V-blades.

FIG. 4a shows a rear perspective view of an exhibit apparatus for snowplows.

FIG. 4b shows a rear perspective view of an exhibit apparatus for snowplows.

FIG. 4c shows a rear perspective view of an exhibit apparatus for snowplows.

FIG. 4d shows a side view of an exhibit device for snowplows with straight blades.

FIG. 5 is a cut-away detail of FIG. 4c.

FIG. 6 is a cut-away detail of FIG. 4c.

FIG. 7 is a cut-away detail of FIG. 4c.

FIG. 8 is a cut-away detail of FIG. 4c.

FIG. 9 is a cut-away detail of FIG. 4a.

FIG. 10 is a cut-away detail of FIG. 4d.

FIG. 11 is a cut-away detail of FIG. 4d.

FIG. 12 is a cut-away detail of FIG. 4d.

### IV. DETAILED DESCRIPTION

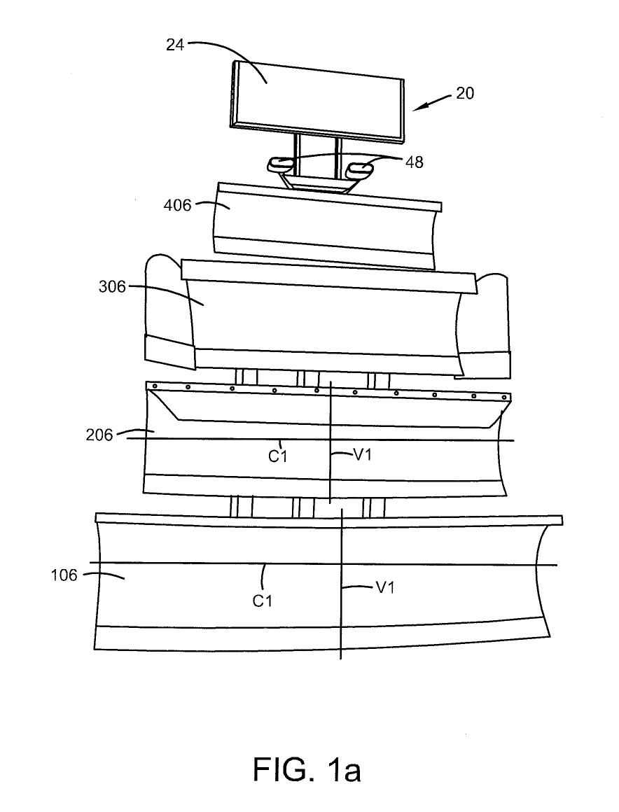

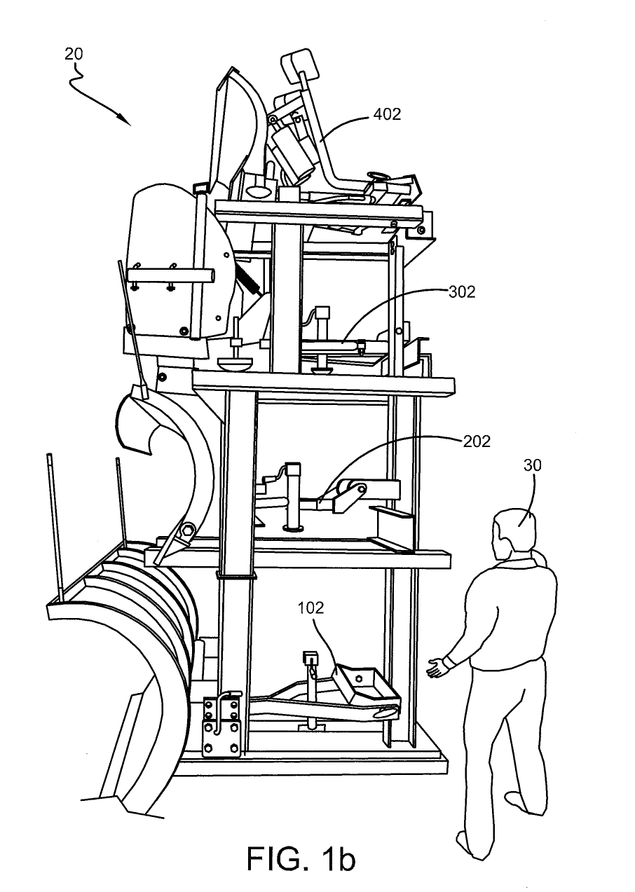

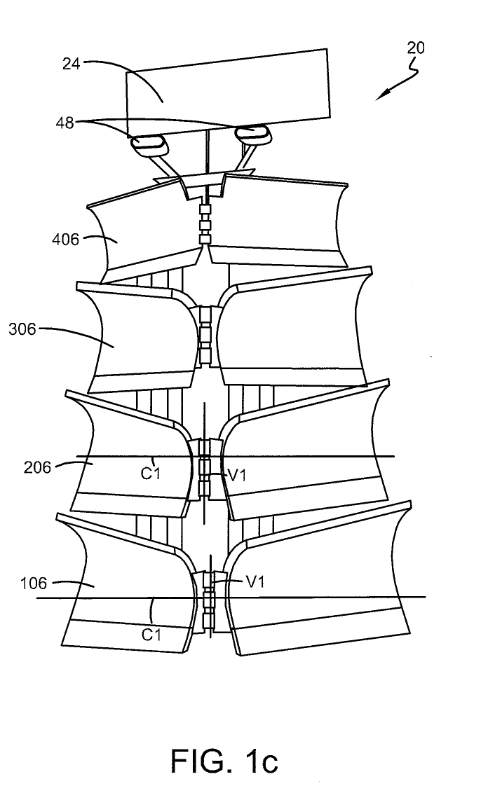

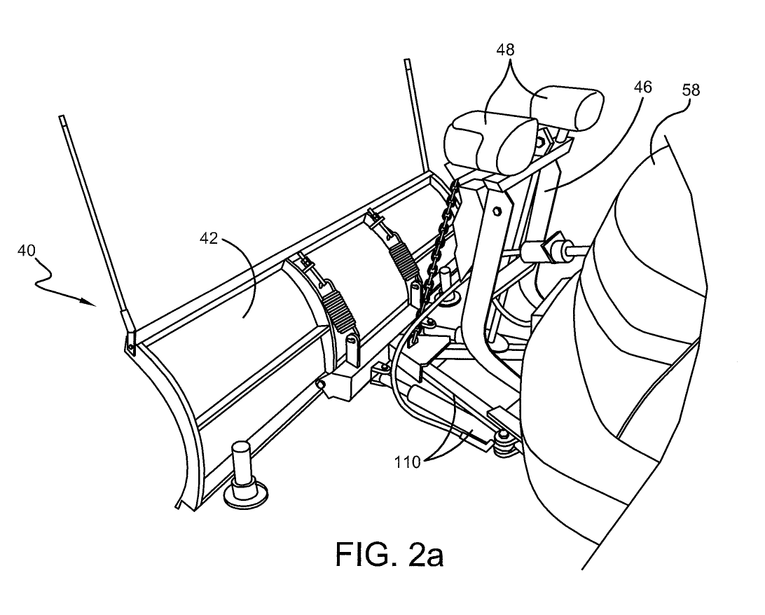

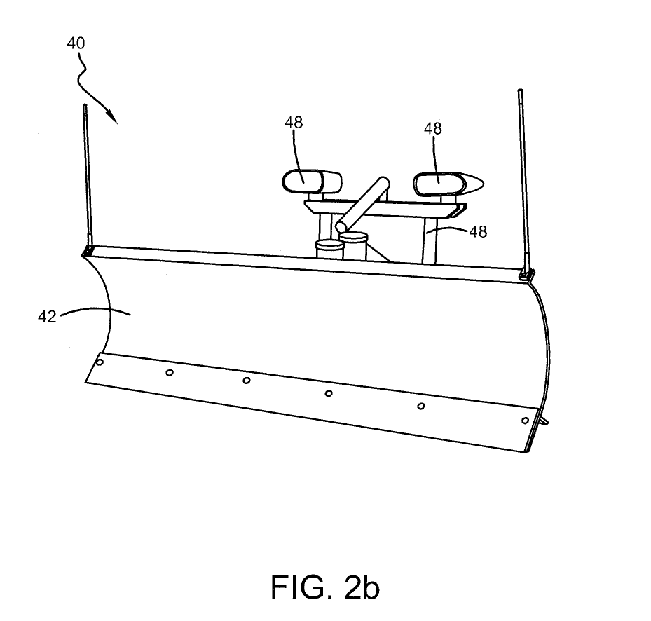

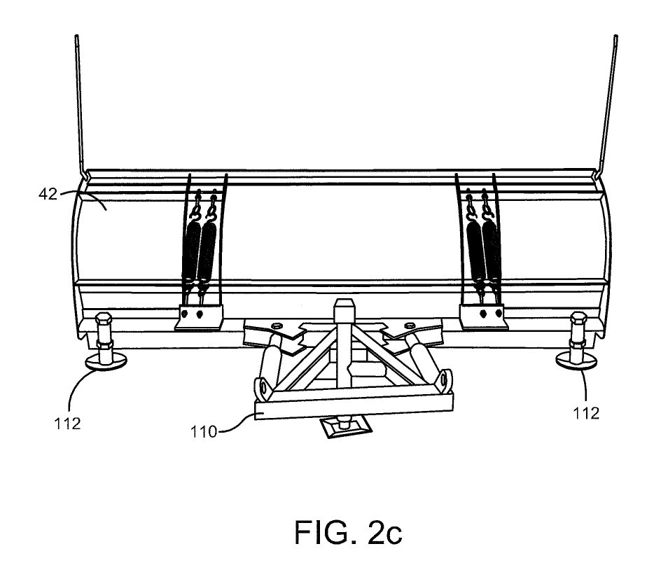

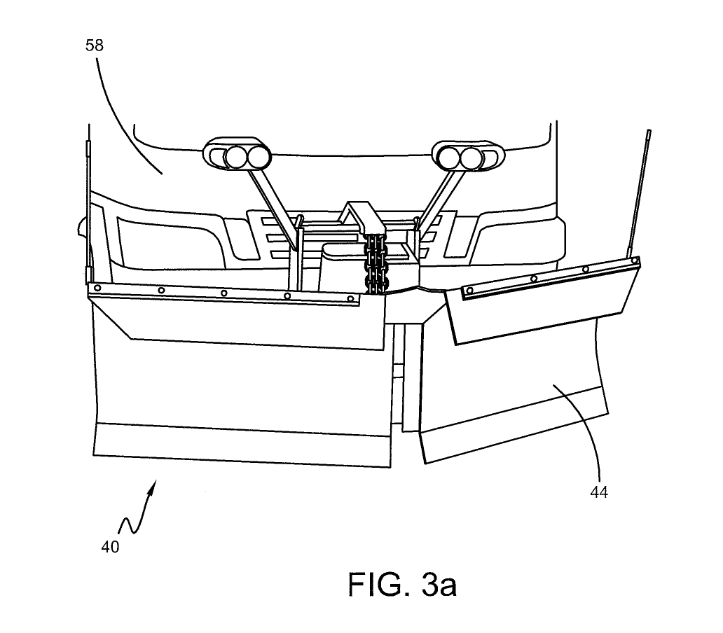

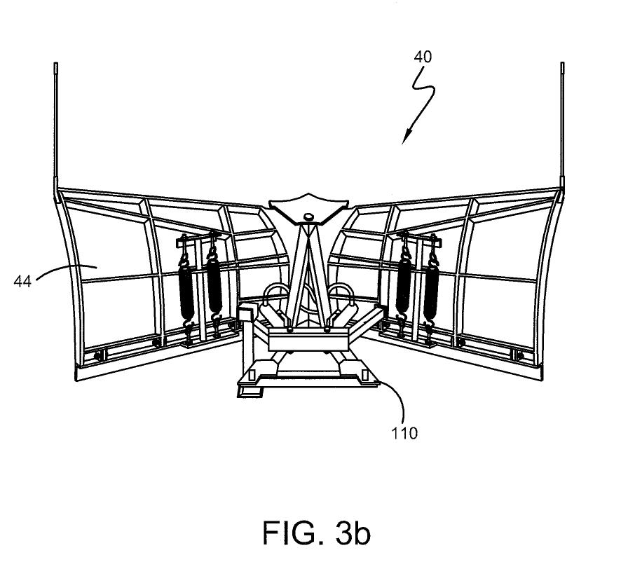

Referring now to the drawings wherein the showings are for purposes of illustrating embodiments of the invention only and not for purposes of limiting the same, and wherein like reference numerals are understood to refer to like components, FIGS. 1a, 1b, and 1c, show a snowplow exhibit apparatus 20 that is used to display snowplows. The snowplows displayed on the snowplow exhibit apparatus 20 may be of any type and size chosen with the sound judgment of a person of skill in the art. In one non-limiting example, the snowplows 40 may have straight blades 42 as shown in FIGS. 2a, 2b, and 2c. In another non-limiting example, the snowplows 40 may have V-blades 44 as shown in FIGS. 3a and 3b. It is also contemplated to mix snowplow types on the same snowplow exhibit apparatus 20. In yet another non-limiting example, shown in FIGS. 1a and 1c, the sizes of the snowplows may decrease from the bottom of the snowplow exhibit apparatus 20 to the top. It is also contemplated to use similarly sized snowplows on the same snowplow exhibit apparatus 20.

With continuing reference to FIGS. 1a, 1b, 1c, it should be noted that the snowplow exhibit apparatus 20 of the present invention is for use with functional snowplows 40—not for toy snowplows. Thus, in one embodiment each snowplow 102, 202, 302, and 402 weighs at least 50 pounds. In another embodiment each snowplow 102, 202, 302, and 402 weighs at least 100 pounds. In yet another embodiment each snowplow 102, 202, 302, and 402 weighs at least 300 pounds. In yet another embodiment each snowplow 102, 202, 302, and 402 weighs at least 500 pounds. In yet another embodiment each snowplow 102, 202, 302, and 402 weighs at least 1000 pounds. It is also contemplated to use different weight snowplows on the same snowplow exhibit apparatus 20, where the weight of the snowplows increases from the bottom to the top. The first level snowplow will typically be the heaviest one among the snowplows for displaying, and the ground-level snowplows may provide additional ground-contacting feet 112 that are additional supporting structure for the exhibit apparatus 20.

As shown in FIG. 1a, 1b, 1c, a first snowplow display structure 100 is used to support a first snowplow 102 weighing at least 50 pounds at a first height. A second snowplow display structure 200 is connected to the first snowplow display structure 100 and is used to support a second snowplow 202 weighing at least 50 pounds at a second height that is substantially higher than the first height. The first and second snowplows 102, 202 are supported to the first and second snowplow display structures 100, 200. The first and second snowplows 102, 202 are both simultaneously visible to an observer 30 near the snowplow exhibit apparatus 20.

With reference now to FIGS. 2a, 2b, and 2c the snowplow 40, as is well known to those of skill in the art, may include a snowplow blade 42 and a plow mount 110. The snowplow blade 42 is used to push snow, ice and the like from roadways. The plow mount 110 may be used to connect the snowplow blade 42 to a vehicle 58 in any known manner. The plow mount 110 may include a lift frame 46. Additionally, the plow mount 110 may include lights 48, lifting mechanisms, hydraulic systems, ram mechanisms, jack stands, and other optional components, which are all well known to those of skill in the art. As snowplows, including their sizes and operation, are well known to those of skill in the art, further details will not be provided except as noted below.

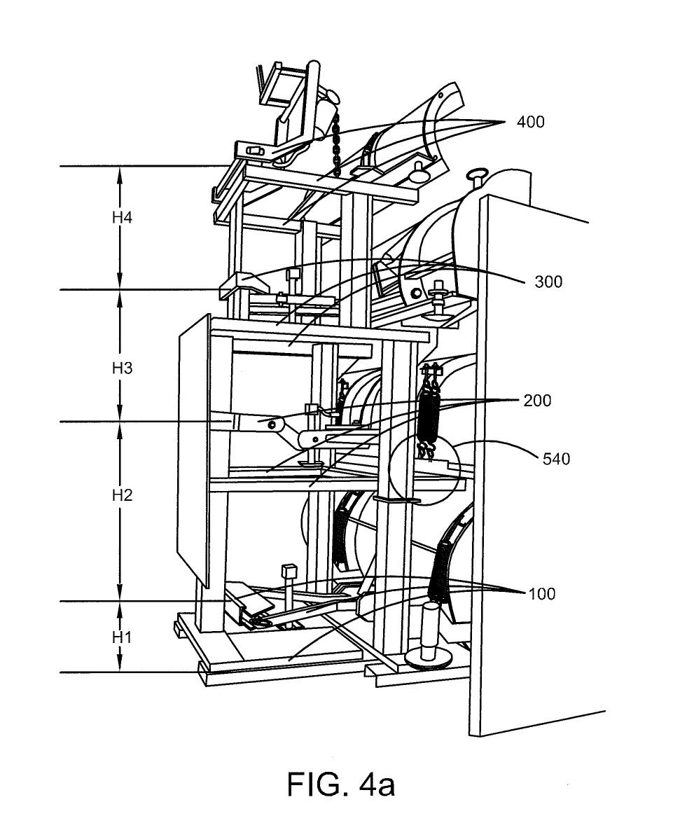

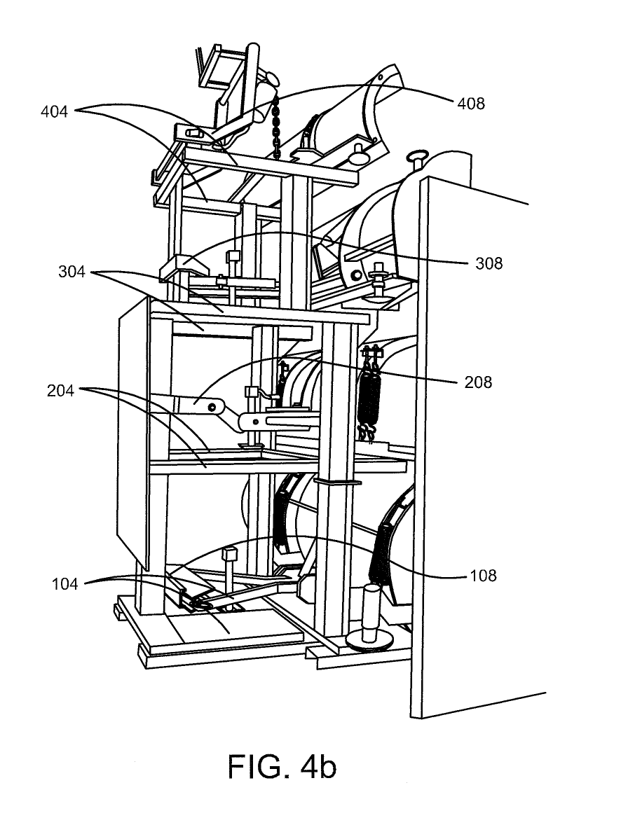

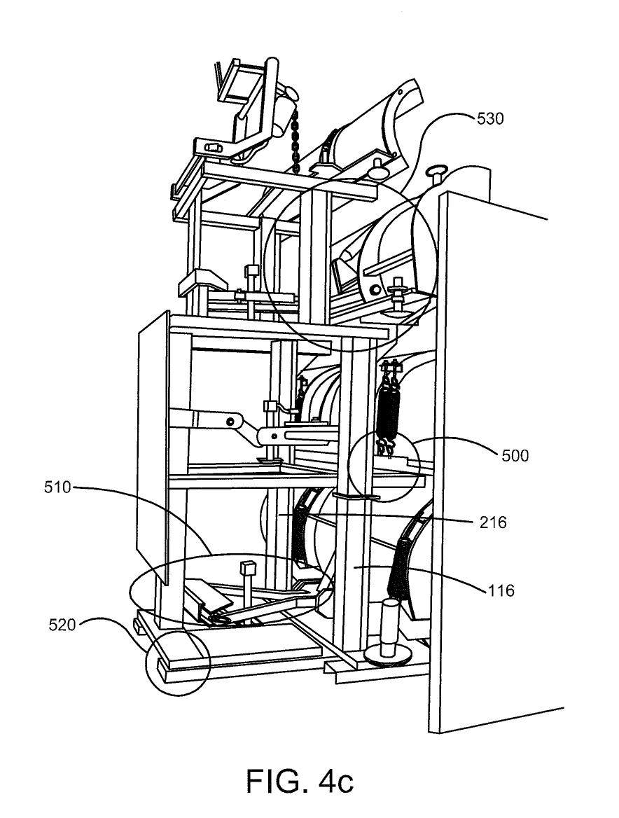

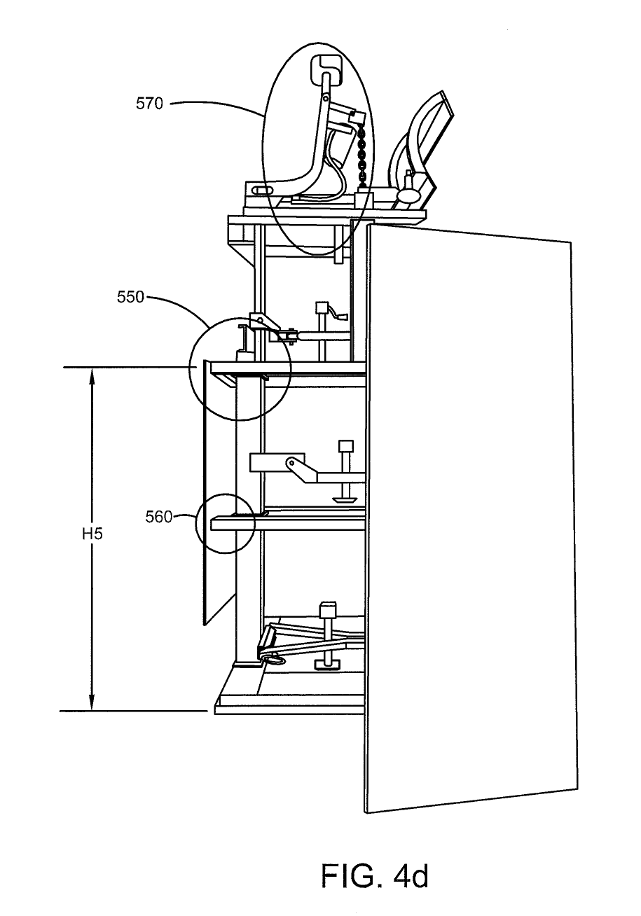

With reference now to FIG. 4a, the snowplow exhibit apparatus 20 may have a snowplow display structure 100 which is used to support the snowplow 102 in a display. In one embodiment shown in FIG. 4c, the snowplow exhibit apparatus 20 includes four snowplow display structures 100, 200, 300, and 400 holding four snowplows 102, 202, 302, and 402. As shown, each snowplow display structure 100, 200, 300, and 400 displays the corresponding snowplow 102, 202, 302, and 402 at a corresponding different height H1-H4. In the embodiments which contain a connection structure H1 is measured from the floor or surface upon which the snowplow exhibit apparatus rests to the first connection structure 108. In the embodiments which contain a connection structure, H2 is measured from the first connection 108 structure to the second connection structure 208. In the embodiments which contain a connection structure, H3 is measured from the second connection structure 208 to the third connection structure 308. In the embodiments which contain a connection structure, H3 is measured from the third connection structure 308 to the fourth connection structure 408. In another embodiment the first height H1 can be suitable to allow the bottom of the snowplow blade 106 to be in contact with the surface or floor upon which the apparatus rests. The second height H2 may be 0.1 times to 2 times height of the first snowplow blade 106. The third height H3 may be 0.1 times to 2 times height of the second snowplow blade 206. The fourth height H4 may be 0.1 times to 2 times height of the third snowplow blade 306.

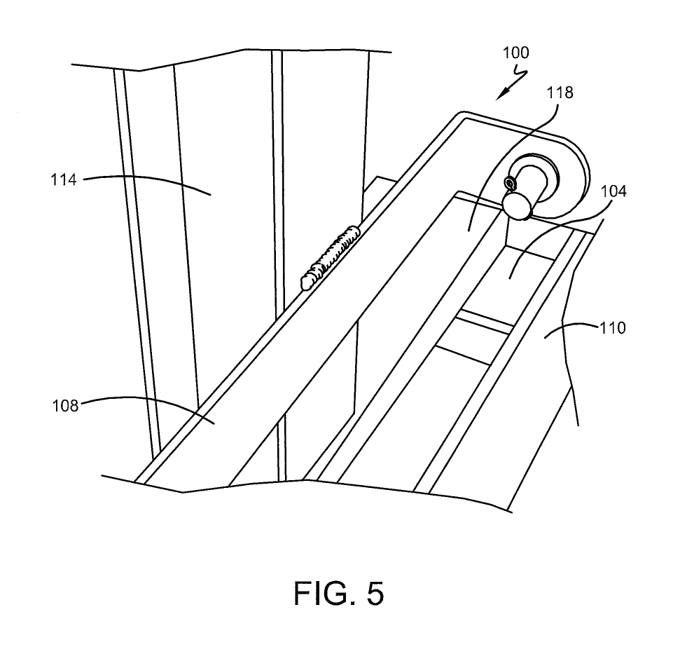

With reference now to FIG. 4b, each snowplow display structure 100, 200, 300, and 400 may comprise platforms 104, 204, 304, and 404 that are suitable to support snowplow blades 106, 206, 306, and 406. The platforms 104, 204, 304, and 404 may be comprised of a beam, pillar, brace, plate, panel, sheet, plank, board, slat, pole, post, or other suitable member chosen with sound engineering judgment. In one embodiment, as detailed in FIG. 5 at least one platform may optionally include one or more crossbeams 118, 218, 318, 418 for additional structural support. Said crossbeams may be connected to at least one platform at any point chosen with sound engineering judgment along, optionally the front, midpoint, and/or the rear of a platform. In one embodiment a crossbeam 118, 218, 318, 418 may be located perpendicular to a platform 104, 204, 304, 404 such that a plow mount 110, 210, 310, 410 rests on a crossbeam.

With continuing reference to FIGS. 4b and 5, in one embodiment each of the snowplow display structures 100, 200, 300, and 400 may also comprise a corresponding connection structure 108, 208, 308, and 408 that is suitable to connect to a plow mount 102, 202, 302, and 402 in any manner chosen with the sound judgment of a person of skill in the art.

With reference to FIG. 4c, in one embodiment, the snowplow exhibit apparatus 20 may include at least a first arm 116 perpendicularly extended from first platform 104, second platform 204, third platform 304, or fourth platform 404. The arm may also connect the first platform 104 to any other platform in the apparatus. In another embodiment the arm may extend from the ground to any platform. In yet another embodiment the snowplow exhibit apparatus may include at least a second arm 216, perpendicularly extended from first platform 104, second platform 204, third platform 304, or fourth platform 404. The second arm 216 may also connect the second platform 204 to any other platform in the apparatus. In another embodiment the second arm may extend from the second platform to any other platform.

With reference now to FIG. 5 greater detail is shown as to one embodiment. In this embodiment each plow mount 110, 210, 310, 410 may be operatively attached to a connection structure 108, 208, 308, 408. The each connection structure 108, 208, 308, 408 may be secured to at least one support member 114, 214, 314, 414 by a securement means. The securement means may be a bolt, pin, welding joint or other means know to those of skill in the art. The support member may be a wall, beam, pillar, brace, underpinning, pole, post, I-beam, HSS beam or other suitable member chosen with sound engineering judgment. In one embodiment any one of the support members 114, 214, 314, 414 may be oriented perpendicular to any platform and connect one or more platform to another platform adjacent thereto.

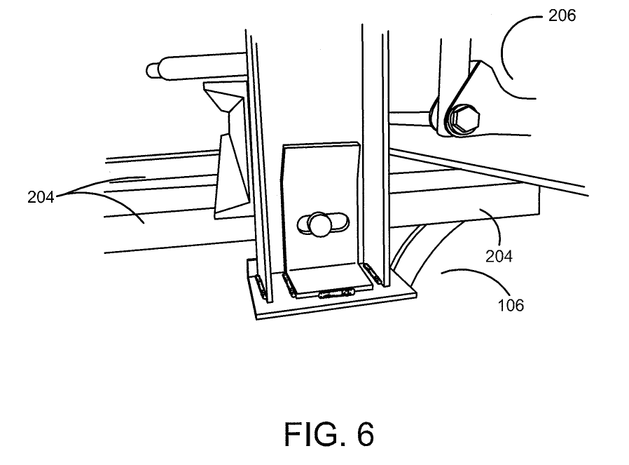

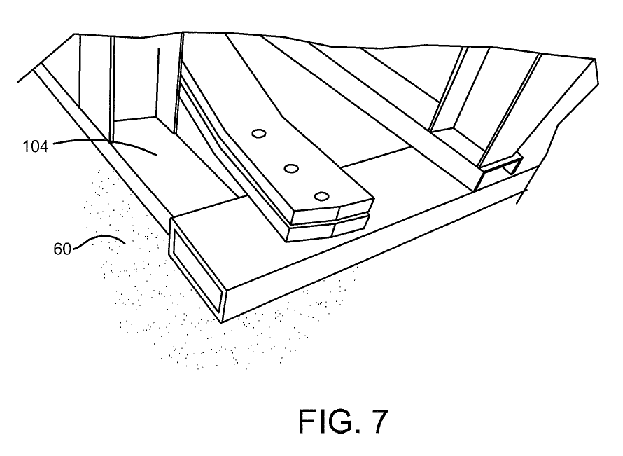

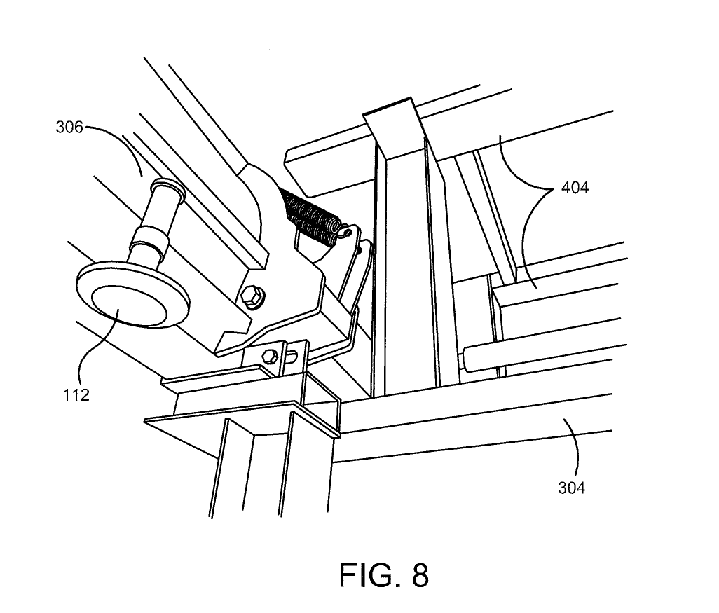

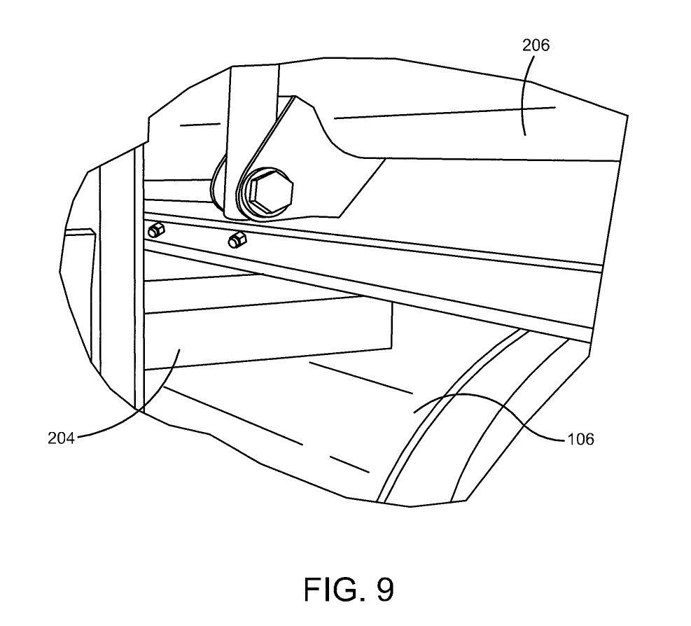

With reference now to FIGS. 4a, 6-9, the first snowplow display structure 100 includes a first platform 104 that supports a snowplow blade 106 of the first snowplow 102. The first snowplow display structure 100 also includes a connection structure 108 that is suitable to connect to a plow mount 110 of the first snowplow 102. The first connection structure 108 is at a first height H1. Optionally, in one embodiment the first height H1 is suitable such that the first snowplow blade 106 rests on the floor 60. In yet another embodiment first height H1 is suitable such that the ground contacting feet 112 of the first snowplow 102 may rest on the floor or surface 60 upon which the apparatus rests. The second snowplow display structure 200 also includes a second platform 204 that supports a second snowplow blade 206 of the second snowplow 202. In one embodiment the second snowplow display structure 200 also includes a second connection structure 208 that connects to a second plow mount 210 of the second snowplow 202. The second connection structure 208 is at a second height H2 that is substantially higher than the first height H1. In yet another embodiment a third snowplow display structure 300 also includes a third platform 304 that supports a third snowplow blade 306 of the third snowplow 302. The third snowplow display structure 300 may also include a third connection structure 308 that connects to a third plow mount 310 of the third snowplow 302. The third connection structure 308 is at a third height H3 that is substantially higher than the first height H1. In yet another embodiment, an optional fourth snowplow display structure 400 may include a fourth platform 404 that supports a fourth snowplow blade 406 of the fourth snowplow 402. The fourth snowplow display structure 400 may include a fourth connection structure 408 that connects to a fourth plow mount 410 of the fourth snowplow 402. The fourth connection structure 408 is at a fourth height H4 that is substantially higher than the first height H1.

With reference now to FIGS. 1a, 1b, 1c the first and second snowplows 102, 202 each have a snowplow blade 106, 206 with a vertical centerline V1, V2 and a horizontal centerline C1, C2. In yet another embodiment, the first and second snowplows 102, 202 are supportable to the first and second snowplow display structures 100, 200 such that the plane formed by the first horizontal and the first vertical centerlines C1, V1 is on substantially the same plane as that formed by the second vertical and second horizontal centerlines V2, C2 such that the snowplows can be directly over top each other (as shown). In yet another embodiment, the first plane formed by the first horizontal centerline C1 and the first vertical centerline V1 occupies a space that is substantially distinct from a second plane formed by the second vertical centerline V2 and the second horizontal centerline C2 such that the snowplows are not directly over top each other but can be off-set.

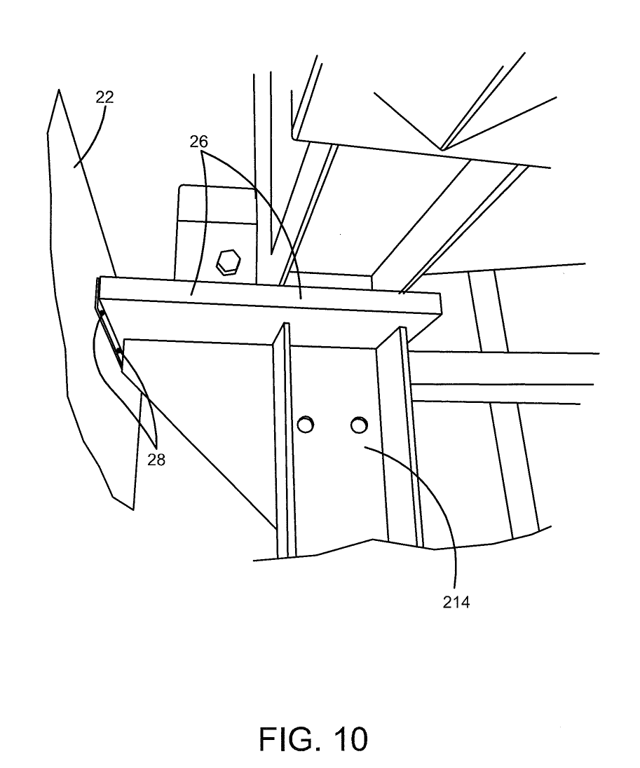

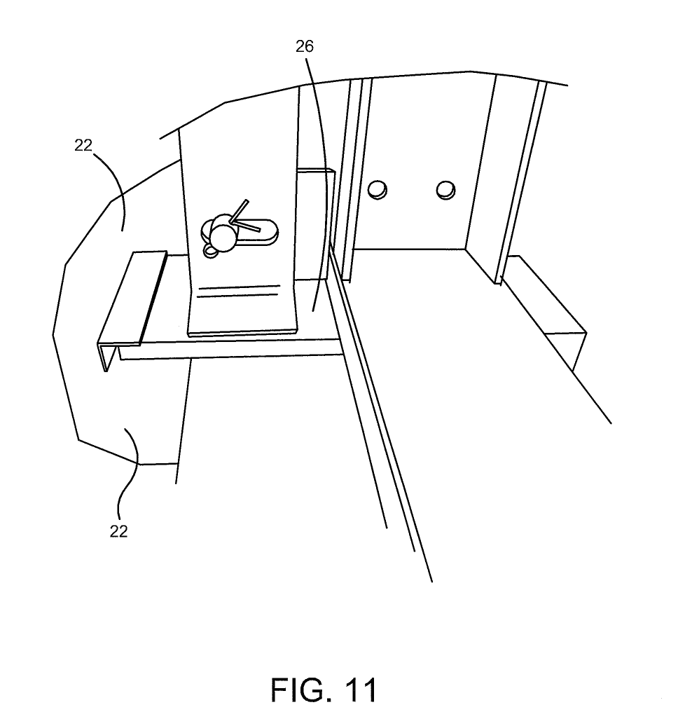

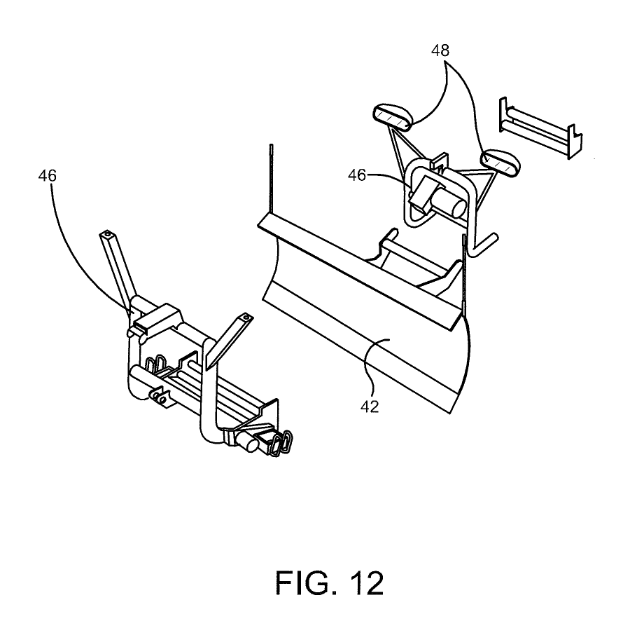

With reference now to FIGS. 4d, 10-12, the snowplow exhibit apparatus may also include a signage support structure 26 that is suitable to support an first sign 22 at a fifth height H5 that is substantially higher than the second height H2. In one embodiment the signage support structure 26 may be perpendicularly connected to the second support member 214. In yet another embodiment the signage support structure 26 may comprise a ledge. A sign 22 may be attached to the signage support structure 26 using an attachment means 28. Said attachment means 28 may include a screw, nail, glue, bolt, pin, welding joint, hook and loop fastener, or other means known to those of skill in the art. Additionally, the snowplow exhibit apparatus may also include a lift frame 46. In one embodiment a second sign 24 is attached to lift frame 46 using an attachment means 28.

Each structure of the apparatus 20 is tested for the largest possible load with the center of weight to be defined as specified by the snowplow manufacturer, where the center of the weight of the apparatus 20 is designed to minimize torque to avoid the tipping over of the apparatus 20. The various forces and torques on the structure were simulated and tested so that the forces and torques on the structure would allow safe operation of the exhibit apparatus. The heaviest types of snowplows for display are usually placed on the first snowplow display structure, and the lighter varieties are usually placed on a second, third or fourth snowplow display structure.

In one embodiment, the third and fourth snowplow display structure 300, 400 may occupy less area than the first or second snowplow display structure 100, 200. Referring now to FIG. 4a, the third and fourth snowplow display structures 300, 400 occupy less area to substantially improve the overall stability of the exhibit apparatus 20. The center of the weight for the third and fourth snowplow then will be within the surface area of the first and second snowplow. For example, the fourth platform 404 is included within the surface expanded by the second platform 204 of the second snowplow display structure 200, so that the torque on the exhibit apparatus 20 can be minimized to reduce the chance of tip over.

A method of using the snowplow exhibit apparatus 20 will now be described. The method related to the usage of a snowplow exhibit apparatus 20. The snowplow exhibit apparatus includes: a first snowplow display structure 100; and, a second snowplow display structure 200 that is connected to the first snowplow display structure 100. Further, the first snowplow display structure 100 includes a first platform 104 and a first connection structure 108. Next, the second snowplow display structure 200 with a platform 204 and a connection structure 208 are provided for supporting a second snowplow 202. Then, the first and second snowplows 102, 202 are provided to be supported by the corresponding display structure 100, 200. The first snowplow 102 includes a first snowplow blade 106 and a first plow mount 110; and, the second snowplow 202 includes a second snowplow blade 206 and a second plow mount 210. Then one can mount the first snowplow 102 to the first snowplow display structure 100 at a first height H1 and support the first snowplow blade 106 of the first snowplow 102 on the platform 104 of the first snowplow display structure 100 and connect the plow mount 110 of the first snowplow 102 to the connection structure 108 of the first snowplow display structure 100. Then, the next step will be mounting the second snowplow 202 to the second snowplow display structure 200 at a second height H2 that is higher than the first height H1 and support the snowplow blade 206 of the second snowplow 202 on the platform 204 of the second snowplow display structure 200 and, connect the second plow mount 210 of the second snowplow 202 to the connection structure 208 of the second snowplow display structure 200. After the above steps accomplished, the first and second snowplows are both simultaneously visible to an observer 30 near the snowplow exhibit apparatus 20.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A snowplow exhibit apparatus comprising:
a first snowplow display structure that is suitable to support a first associated snowplow weighing at least 50 pounds at a first height;
a second snowplow display structure that is connected to the first snowplow display structure and that is suitable to support a second associated snowplow weighing at least 50 pounds at a second height that is substantially higher than the first height; and,
wherein the first and second associated snowplows are both simultaneously visible to an associated observer near the first and second snowplow display structures.

2. The snowplow exhibit apparatus of claim 1 wherein:
the first snowplow display structure comprises: a platform that is suitable to support a first snowplow blade of the first associated snowplow; and, a connection structure that is suitable to connect to a first plow mount of the first associated snowplow; and,
the second snowplow display structure comprises: a second platform that is suitable to support a second snowplow blade of the second associated snowplow; and, a second connection structure that is suitable to connect to a second plow mount of the second associated snowplow.

3. The snowplow exhibit apparatus of claim 2 wherein at least one support member is attached to the first or second connection structure.

4. The snowplow exhibit apparatus of claim 2 wherein at least one arm is attached to the first or second platform.

5. The snowplow exhibit apparatus of claim 2 wherein at least one crossbeam is attached to the first or second platform.

6. The snowplow exhibit apparatus of claim 1 wherein:
the first associated snowplow has a snowplow blade with a first vertical centerline and a first horizontal centerline;
the second associated snowplow has a snowplow blade with a second vertical centerline and a second horizontal centerline; and
a first plane formed by the first horizontal centerline and the first vertical centerline occupies a space that is substantially identical to a second plane formed by the second vertical centerline and the second horizontal centerline.

7. The snowplow exhibit apparatus of claim 1 wherein:
the first associated snowplow has a snowplow blade with a first vertical centerline and a first horizontal centerline;
the second associated snowplow has a snowplow blade with a second vertical centerline and a second horizontal centerline; and
a first plane formed by the first horizontal centerline and the first vertical centerline occupies a space that is substantially distinct from a second plane formed by the second vertical centerline and the second horizontal centerline.

8. The snowplow exhibit apparatus of claim 1 wherein: the first height is suitable such that a bottom of a snowplow blade of the first associated snowplow is in contact with a surface upon which the snowplow display structure rests.

9. The snowplow exhibit apparatus of claim 1 further comprising:
a signage support structure that is suitable to support an associated sign at a fifth height that is substantially higher than the second height,
wherein the signage support structure is attached to the first or second snowplow display structure, and
wherein an associated sign is attached to the signage support structure using an attachment means.

10. The snowplow exhibit apparatus of claim 1 further comprising:
a lift frame attached to the first or second snowplow display structure; and
a sign attached to said lift frame.

11. The snowplow exhibit apparatus of claim 1 further comprising:
at least one foot attached to said first associated plow and
wherein the first height is such that said foot contacts a surface.

12. A snowplow exhibit apparatus comprising:
a first snowplow display structure that is suitable to support a first associated snowplow at a first height;
a second snowplow display structure that is connected to the first snowplow display structure and that is suitable to support a second associated snowplow at a second height that is substantially greater than the first height;
a third snowplow display structure that is connected to the second snowplow display structure and that is suitable to support a third associated snowplow weighing at least 50 pounds at a third height that is substantially greater than the second height; and,
wherein the first, second, and third associated snowplows are simultaneously visible to an associated observer near the first and second snowplow display structures.

13. The snowplow exhibit apparatus of claim 12 wherein:
the first snowplow display structure comprises: a platform that is suitable to support a snowplow blade of the first associated snowplow; and, a connection structure that is suitable to connect to a plow mount of the first associated snowplow;
the second snowplow display structure comprises: a second platform that is suitable to support a snowplow blade of the second associated snowplow; and, a second connection structure that is suitable to connect to a plow mount of the second associated snowplow; and,
the third snowplow display structure comprises: a third platform that is suitable to support a snowplow blade of the third associated snowplow; and, a third connection structure that is suitable to connect to a plow mount of the third associated snowplow.

14. The snowplow exhibit apparatus of claim 12 where in the platform comprises at least one solid panel.

15. The snowplow exhibit apparatus of claim 12 further comprising:
a lift frame attached to the third snowplow display structure; and
a sign attached to said lift frame.

16. The snowplow exhibit apparatus of claim 12 wherein:
the third snowplow support structure occupies an area that is substantially less than the area occupied by the first snowplow support structure.

17. The snowplow exhibit apparatus of claim 12 wherein:
the third height is in a range of 0.1 times to 2 times a height of a second snowplow blade of the second snowplow.

18. The snowplow exhibit apparatus of claim 12 further comprising:
a fourth snowplow display structure that is connected to the third snowplow display structure and that is suitable to support a fourth associated snowplow weighing at least 50 pounds at a fourth height that is substantially higher than the third height.

19. The snowplow exhibit apparatus of claim 17 further comprising:
a lift frame attached to the fourth snowplow display structure; and
a sign attached to said lift frame.

20. A method of constructing a snowplow exhibit apparatus comprising the steps of:
(A) providing a snowplow exhibit apparatus comprising: a first snowplow display structure; and, a second snowplow display structure that is connected to the first snowplow display structure;
(B) providing first and second snowplows each weighing at least 50 pounds;
(C) mounting the first snowplow to the first snowplow display structure at a first height;
(D) mounting the second snowplow to the second snowplow display structure at a second height that is substantially higher than the first height; and,
wherein after steps (A) through (D) the first and second snowplows are both simultaneously visible to an associated observer near the snowplow exhibit apparatus.
